(19) United States
(12) Patent Application Publication
(10) Pub. No.: US 2007/0040124 A1
(43) Pub. Date: Feb. 22, 2007

(54) Coded aperture imager

(75) Inventor: Roberto Accorsi, St. Davids, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: The Children's Hospital of Philadelphia

(21) Appl. No.: 10/557,062

(22) PCT Filed: Apr. 28, 2004
(86) PCT No.: PCT/US04/13250

§ 371 Date: Nov. 15, 2005

Related U.S. Application Data
(60) Provisional application No. 60/471,161, filed on May 16, 2003.

(51) Int. Cl. G01T 1/164

(52) U.S. Cl. 250/363.06

(57) ABSTRACT

The invention is based on the discovery that using at least two detectors in near-field imaging, wherein each detector is located on opposing sides of an object at about a 180 degree angle relative to the other detector, and equipping the detectors with two different copies of the same coded aperture, rotated at about a 90 degree angle relative to each other, minimizes near-field artifacts in images of non-static objects. The near-field coded aperture device and a method for minimizing artifacts by utilizing the device are provided. A method for detecting contraband in cargo is also provided.

### CROSS-REFERENCE TO RELATED APPLICATIONS

This application claims a benefit of U.S. Provisional Application No. 60/471,161 filed on May 16, 2003 entitled CODED APERTURE IMAGER WITH NEAR-FIELD ARTIFACT CORRECTION FOR DYNAMIC STUDIES which is incorporated herein in its entirety.

### STATEMENT REGARDING FEDERALLY SPONSORED RESEARCH OR DEVELOPMENT

This research was supported in part by U.S. Government funds (Grant Number DATM-05-02-C-0034), and the U.S. Government may therefore have certain rights in the invention.

### BACKGROUND OF THE INVENTION

1. Field of Invention

This invention relates to molecular imaging, and more particularly to a near-field coded aperture imaging system for generating and displaying an image that is representative of a source of non-focusable radiation, such as a gamma ray or an x-ray source in near-field geometry. More particularly, the invention relates to the correction of artifacts in near-field coded aperture images of dynamic studies.

2. Description of Related Art

Application of classic coded aperture methods to near-field imaging results in artifacts that corrupt the images (see Accorsi et al., “A Coded Aperture for High-Resolution Nuclear Medicine Planar Imaging With a Conventional Anger Camera: Experimental Results”, IEEE Transactions on Nuclear Science, 48, 6, 2411-2417, 2001). Attempts have been made to reduce such artifacts in taking images of static objects (see Accorsi et al., “Near-field artifact reduction in Coded Aperture Imaging”, Applied Optics, 40, 26, 4697-4705, 2001). The method comprises acquiring two images of the same object, wherein one image is acquired using a coded aperture, and another image is acquired using a coded aperture having open and closed positions interchanged.

It has also been shown that certain coded apertures are anti-symmetric, and therefore it is possible to take two pictures with the same aperture. The second image is taken after rotating the aperture. See Jayanthi et al., “Physical implementation of an antimask in URA based coded mask systems”, Nuclear Instruments and Methods in Physics Research, A310, 685-689, 1991. When the two images are reconstructed, they will show the same object corrupted by artifacts. However, the artifacts are different in the two images. In particular, the artifacts have different shapes. Therefore, upon summation of the two images, the desirable object is reinforced and artifacts are canceled out providing a clear picture.

A published application U.S. Pat. No. 20020075990A1 to Lanza et al. teaches reducing and/or eliminating artifacts in near field imaging applications by combining images obtained from passing a signal through (1) two masks having decoding arrays which are negatives of each other (a mask and a negative mask), wherein the masks are consecutively placed or (2) one mask which is then rotated about its center by a certain angle (e.g., 90°). Further, a single detector detects signals passing through the first mask and then, the second mask wherein the second mask can be a separate mask from the first mask or it can be the same mask, which is rotated by 90°. This reference does not disclose using more than one detector to detect signals passing through at least two masks simultaneously. Further, this reference does not teach using the two masks simultaneously. Finally, this reference does not disclose taking images of a moving object.

McConnell et al. discloses the application of similar steps for the purpose of compensating for the effects of detector non-uniformities and non-encoded background in far-field imaging for static objects (see “A coded aperture gamma ray telescope”, IEEE Transactions on Nuclear Science, NS-29, 155-159, 1982).

Although the known methods for removing artifacts from near-field images by rotating the same mask is effective for static objects, it is not designed for acquiring near-field images of moving objects. If the object has moved during imaging (or in the time between the two images), the two images obtained before and after the movement would not be consistent, and in the summation image, the object would not superimpose onto itself and artifacts would not cancel out exactly.

Accordingly, it is desired to provide a method and system for acquiring near-field images of non-static objects, wherein near-field artifacts are minimized.

All references cited herein are incorporated herein by reference in their entireties.

### BRIEF SUMMARY OF THE INVENTION

The present invention provides a near-field coded aperture device comprising:

at least two coded apertures placed at about a 90 degree angle relative to each other; and

at least two detectors placed on opposite sides of an object and at about a 180 degree angle relative to each other, wherein each of the at least two detectors is in communication with the at least two coded apertures and wherein the at least two detectors produce detection signals to acquire at least two images of the object substantially simultaneously.

Further provided is a method for minimizing artifacts in a near-field coded aperture image of an object, said method comprising:

providing at least two coded apertures at about a 90 degree angle relative to each other;

providing at least two detectors on opposite sides of the object at about a 180 degree angle relative to each other, wherein each of the at least two detectors is in communication with the at least two coded apertures;

obtaining at least two images of the object simultaneously; and

processing the at least two images to form one composite image having minimized near-field artifacts.

Still further provided is a method of detecting contraband in cargo comprising:

providing at least two coded apertures at about a 90 degree angle relative to each other;

providing at least two detectors on opposite sides of the cargo at about a 180 degree angle relative to each other, wherein each of the at least two detectors is in communication with the at least two coded apertures and produce detection signals;

providing a data processor for characterizing at least one characteristic of the cargo, the at least one characteristic being indicated by an origin, amount and/or energy spectra of radiation emitted from the cargo, as determined by the detection signals, and a configuration of the at least two coded apertures; and

obtaining at least two images of the object simultaneously; and

processing the at least two images to form one composite image having minimized near-field artifacts.

### BRIEF DESCRIPTION OF SEVERAL VIEWS OF THE DRAWINGS

The invention will be described in conjunction with the following drawings in which like reference numerals designate like elements and wherein:

FIG. 1 is a perspective schematic view of a near-field coded aperture device according to the invention; and

FIG. 2 is another perspective schematic view of another near-field coded aperture device according to the invention.

FIG. 3 is an illustration of a coded aperture mask used in the examples below. No Two Holes Touching (NTHT) MURA, 38×38, mosaicked, pattern centered, and anti-symmetric about center.

### DETAILED DESCRIPTION OF THE INVENTION

The present invention is aimed at minimizing or correcting artifacts in dynamic studies of an object in a near-field imaging. Near-field artifacts can arise from several non-idealities. The most serious sources of artifacts are near-field geometry, out-of focus planes and mask thickness.

The inventor has discovered that using at least two detectors in near-field imaging, wherein each detector is located on opposing sides of an object at about a 180 degree angle relative to the other detector, and equipping the detectors with two different copies of the same coded aperture, rotated at about a 90 degree angle relative to each other, minimizes near-field artifacts in images of non-static objects. The invention can, of course, be used to acquire images of static objects as well. The invention also has the benefit of doubling the overall count rate by better utilization of the heads of a clinical gamma camera. Experimental results show that coded aperture optics can follow the movement of a 370-kBq point source at 0.05 s per frame with 3.5-mm resolution over a 12×12 cm² field of view. Images of a disk source demonstrate that, as in static studies, near-field artifacts can be almost eliminated.

The two detectors simultaneously acquire at least two pictures or images (one for each coded aperture or mask). Less preferably, the images are acquired sequentially. The two images are consistent (i.e., they are images of the same activity distribution) independently of the movements of the object. Upon summation, the object is reinforced and artifacts cancel out.

The term “near-field” imaging is used herein in accordance with its established meaning in the art, and in particular as defined by the inventor in Robert Accorsi, “Design of a near-field coded aperture cameras for high-resolution medical and industrial gamma-ray imaging” MIT Thesis 2001, which also provides a definition of the term “near-field artifacts”.

The present invention is suitable for a wide variety of applications, including: (a) nuclear medicine, where modern instrumentation is typically equipped with opposite identical detectors (heads); (b) medical applications, e.g., in a clinical setting for earlier or improved differential diagnosis; (c) fundamental biological studies of animals and other organisms, including kinetic receptor studies in brain function research, studies of the redistribution of stem cells after injection and the viability of xenografts and therapy assessment in oncology; (d) industrial applications, including damage initiation in materials and relocation in fuel pellets; and (e) security screening.

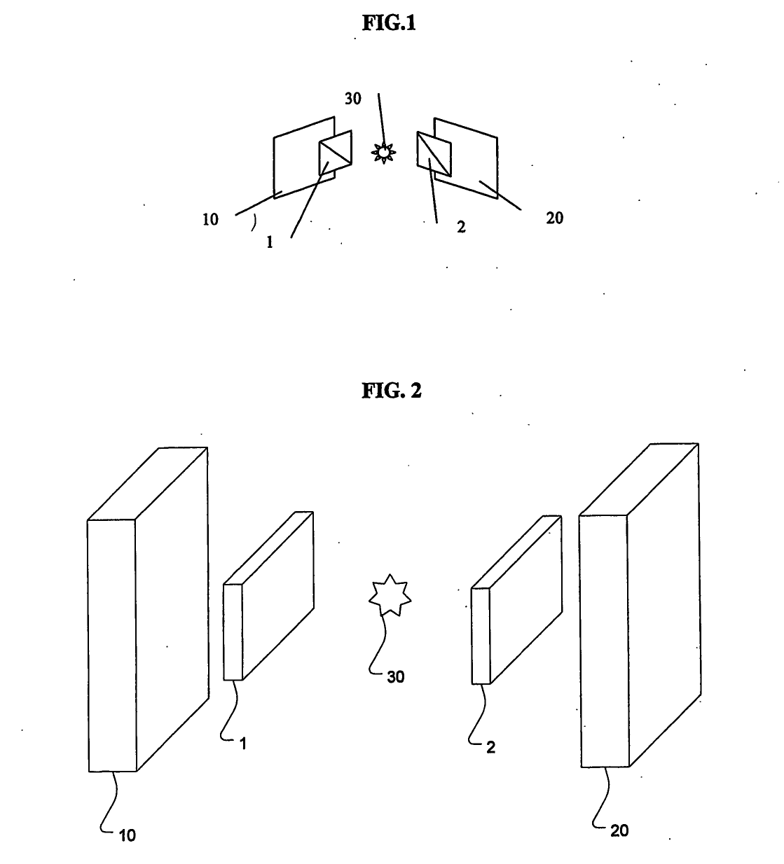

As shown in FIGS. 1 and 2, a near-field coded aperture device of the invention includes two coded apertures 1 and 2 and two detectors 10 and 20. As best appreciated from the view shown in FIG. 2, each aperture is placed on opposing sides of an object 30 and in front of a corresponding one of the two detectors. Thus, aperture 1 and detector 10 are placed at an angle (whose vertex is object 30) of about 180 degrees to aperture 2 and detector 20. In addition, aperture 2 is rotated about 90 degrees (along a plane substantially perpendicular to radiation beams emitted from object 30) relative to aperture 1. Detector 10 is positioned such that radiation emitted from object 30 is detected after passing through aperture 1. Likewise, detector 20 is positioned such that radiation emitted from object 30 is detected after passing through aperture 2. Thus, each of the at least two detectors is in communication with the at least two coded apertures, and is capable of acquiring at least two images of object 30 simultaneously. Distances between a detector, a coded aperture and an object may vary, non-limiting examples of the distances are as follows: the distance between one detector and one coded aperture is about 10 to about 60 cm, preferably about 30 cm, thickness of the aperture is about 0.5 mm to about 2 mm, and the distance between the two apertures is about 10 cm, preferably 3-8 cm.

The detectors of the present invention may consist of a high spatial resolution radiation detector. In an alternative embodiment, an array of semiconductor photodiodes may be used. The array of photodiodes functions in a similar manner to the array of charge coupled devices. It is to be appreciated that other types of low noise sensitive optical imaging assemblies known to persons of ordinary skill in this art may be employed.

The coded apertures useful in the present invention are exemplified in U.S. Pat. No. 5,606,165 to Chiou et al. (which discloses a coded aperture imaging system for imaging a source of non-focusable radiation such as a gamma ray or x-ray emitting source) and U.S. Pat. No. 6,205,195 to Lanza (which discloses a coded aperture imaging apparatus and methods for the detection and imaging of radiation, which results from nuclear interrogation of a target object). It is to be appreciated that other types of coded apertures known to persons of ordinary skill in this art may be employed. Coded apertures can be made by methods known in the art such as electroforming, electrical discharge machining (EDM), photoetching, and laser drilling. Material can be tungsten, molybdenum, gold, and other metals and alloys as well as supporting substrates such as alloy of NiCo. Coded apertures offer particular advantages when point sources are imaged. The movement of weak (e.g., 370 kBq) sources can be followed at very high frame rates (e.g., 20 frames/s) with a conventional gamma camera.

Detector useful in this invention can be gamma cameras as well as other types selected from the group consisting of pixelated (NaI, YAP:Ce, CsI) crystals coupled to a position sensitive photomultiplier tube (PSPMT), pixelated YAP:Ce on PSPMT, pixelated CsI on PSPMT, continuous NaI crystal directly coupled to PSPMT, Cs(I) coupled to a silicon drift detectors (SDD), CdZnTe arrays, 0.6 mm for ⁵⁷Co, and a charge-coupled device.

The invention further provides a method for minimizing artifacts in near-field coded aperture images. The method comprises simultaneously acquiring two near-field images of an object using an apparatus of the invention, and processing the two images to form one composite image having minimized near-field artifacts.

The invention is also useful in the detection of contraband concealed within cargo containers, suitcases, parcels or other objects. As used herein, the term “contraband” includes, but is not limited to, explosives, drugs, and alcohol. The method of detecting contraband in cargo includes providing at least two coded apertures placed at about a 90 degree angle relative to each other; providing at least two detectors placed on opposite sides of the cargo and at about a 180 degree angle relative to each other, wherein each of the at least two detectors is in communication with the at least two coded apertures and produce detection signals; providing a data processor for characterizing at least one characteristic of the cargo, the at least one characteristic being indicated by an origin, amount and/or energy spectra of a radiation emitted from within the cargo, as determined by detection signals, and a configuration of the at least two coded apertures; and obtaining at least two images of the object simultaneously. The invention is especially useful for moving objects, so it can be utilized when the cargo is wherein the cargo is a moving object.

In one preferred embodiment, the nuclear excitation energy source is a beam of fast neutrons. Various neutron sources can be used in the present invention including “sealed tube D-T generators” available from commercial source such as MF Physics, Inc. of Colorado Springs, Colo., or Sodern SA of Paris, France. Alternatively, linear electron accelerators with tungsten-beryllium targets, or radio frequency quadrupole linear accelerators or electrostatic accelerators can also serve as neutron sources. The sources are preferably used in conjunction with reflectors and/or collimators that direct the neutrons into a compact beam for interrogation of the object 30.

Fast neutrons, those with energies above about 1 MeV, are capable of penetrating materials to a depth sufficient for the examination of large objects such as luggage or cargo containers. One embodiment of this invention detects those gamma-rays that are produced by neutron activation of the nuclei of elements that make up the target object, preferably hydrogen, nitrogen, carbon, and/or oxygen and/or combinations thereof. The energy of an individual emitted gamma ray is determined by which nucleus emits the gamma-ray. Thus, measuring the energy and origin point of gamma rays emitted by a target object provides the information necessary to determine the elemental composition of the target object.

When the invention is used in the context of contraband detection by means of fast neutron bombardment, the probing neutrons interact with the contents of the object 30 and induce the material of the object to emit gamma rays.

Appropriate detectors 10 can be positioned to absorb the gamma-rays and to measure their energy.

The invention will be illustrated in more detail with reference to the following Examples, but it should be understood that the present invention is not deemed to be limited thereto.

### EXAMPLES

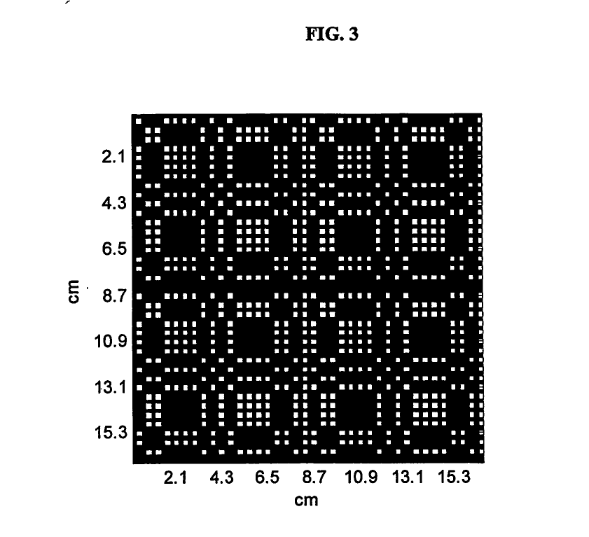

A double-head clinical gamma cameras were used in this experiment. The coded aperture was used as shown in FIG. 3 utilizing the mask pattern NTHT MURA, 38×38, mosaicked, pattern centered, anti-symmetric about center made from Kulite 1750 tungsten alloy by drilling. The mask had the following parameters:

Open fraction (ρ)—0.125;

Mask pixel size—2.2 mm;

Resolution (FoV=11.9 cm): geometric—2.2 mm and system—3.1 mm;

Magnification—3.67;

Thickness—1 mm; and

Attenuation (at 140 keV)—0.969.

To test the method, a disk source was prepared. Data were acquired on both heads with the following parameters:99 mTc in film case:18.5 MBq; 5 s/frame; and 60 frames. The source was moved manually. Adding the mask and anti-mask data removed near-field artifacts.

For point sources, coded apertures reach the same SNR in a time shorter than pinholes by a factor equal to the number of pinholes used (in this case 180). It is possible to image relatively weak sources at extremely high count rates. With the coded aperture used, a 300-kBq point source is imaged with SNR=5 in 15 ms. A pinhole with the same characteristics would need 2:6s.

From the experiment, it was clear the when two detectors are available, it is possible to compensate near-field artifacts in planar coded-aperture studies. Double sensitivity is an added benefit of a more efficient use of the resources. Also, it is possible to image weak point sources (˜370 kBq) at high frame rate (50 ms/frame). For this task, predictions based on contrast-to-noise rather than signal-to-noise calculations better correlate with the visual impression from simulation data.

While the invention has been described in detail and with reference to specific examples thereof, it will be apparent to one skilled in the art that various changes and modifications can be made therein without departing from the spirit and scope thereof.

What is claimed is:

1. A near-field coded aperture device comprising:
at least two coded apertures placed at about a 90 degree angle relative to each other; and
at least two detectors placed on opposite sides of an object and at about a 180 degree angle relative to each other, wherein each of the at least two detectors is in communication with the at least two coded apertures and wherein the at least two detectors produce detection signals to acquire at least two images of the object substantially simultaneously.

2. The device of claim 1, wherein the object is activated to emit a detectable signal, wherein the detectable signal is detected by the at least two detectors.

3. The device of claim 2, wherein the object is activated by a source of nuclear interrogation.

4. The device of claim 1, wherein the object is a moving object or a stationary object.

5. The device of claim 3, wherein the source is a gamma-ray source, an X-ray source or a beam of fast neutrons.

6. The device of claim 1, further comprising a data processor for characterizing at least one characteristic of the object, the at least one characteristic being indicated by an origin, amount and/or energy spectra of radiation emitted from the object, as determined by detection signals, and a configuration of the at least two coded apertures.

7. The device of claim 6, wherein the data processor is adapted to yield a three dimensional image of a predetermined characteristic of the object.

8. The device of claim 7, wherein the predetermined characteristic of the object is the elemental composition of the object.

9. The device of claim 7, wherein the predetermined characteristic of the object is a relative density of predetermined elements in the object.

10. The device of claim 9, wherein the predetermined elements are selected from the group consisting of oxygen, carbon, nitrogen, hydrogen and chlorine.

11. A method for minimizing artifacts in a near-field coded aperture image of an object, said method comprising:
providing at least two coded apertures at about a 90 degree angle relative to each other;
providing at least two detectors on opposite sides of the object at about a 180 degree angle relative to each other, wherein each of the at least two detectors is in communication with the at least two coded apertures;
obtaining at least two images of the object simultaneously; and
processing the at least two images to form one composite image having minimized near-field artifacts.

12. The method of claim 11, wherein the object is a moving object or a stationary object.

13. The method of claim 11, wherein the object is moving.

14. The method of claim 13, wherein the object is activated by nuclear interrogation.

15. A method of detecting contraband in cargo comprising:
providing at least two coded apertures at about a 90 degree angle relative to each other;
providing at least two detectors on opposite sides of the cargo at about a 180 degree angle relative to each other, wherein each of the at least two detectors is in communication with the at least two coded apertures and produce detection signals;
providing a data processor for characterizing at least one characteristic of the cargo, the at least one characteristic being indicated by an origin, amount and/or energy spectra of radiation emitted from the cargo, as determined by the detection signals, and a configuration of the at least two coded apertures; and
obtaining at least two images of the object simultaneously; and
processing the at least two images to form one composite image having minimized near-field artifacts.

16. The method of claim 15, wherein the cargo is a moving object.
